(19) United States
(12) Patent Application Publication
(10) Pub. No.: US 2006/0064937 A1
(43) Pub. Date: Mar. 30, 2006

(54) Weather strip assembly and method of application of same

(76) Inventors: James Anthony Danczek, Winterset, IA (US); Douglas Ray Crain, Urbandale, IA (US)

Correspondence Address: Brian J. Laurenzo;Dorsey & Whitney LLP, Suite 3900, 801 Grand Avenue, Des Moines, IA, 50309, US

(21) Appl. No.: 10/953,835

(22) Filed: Sep. 29, 2004

(51) Int. Cl. E06B 7/16

(52) U.S. Cl. 49/475.1

(57) ABSTRACT

A weather strip assembly and application of same are provided. The weather strip assembly and application comprises a first weather strip operably attached to a first surface, and a second weather strip operably attached to a second surface adjacent the first surface, wherein the second weather strip at least partially overlaps the first weather strip, forming a double seal between adjacent first and second surfaces. The first and/or second weather strip may be applied and secured to the respective surface by adhesive. Further, the weather strip may comprise a cloth fabric.

### FIELD OF THE INVENTION

The present invention relates to the art of weather stripping and, more specifically, to a weather strip for sealing a closure between two moveable objects, such as a double door or window or, between a stationary and moveable object such as a single door and frame, or a single window and frame.

### BACKGROUND

Typically, the assembly of multiple components, such as a door into a frame, is not sufficiently precise to form a tight seal between the two objects. Moreover, no matter how narrow the space between two objects, a gap will always exist between two or more components or adjacent surfaces simply because of surface imperfections. Also, as is known, due to the nature of construction, materials and components shift as they age and settle on any structure whether it be a building, a house, an automobile, a boat and the like. Typically, as a result, the gap surrounding at least a portion of these adjacent surfaces or closures increases. Due to pressure differences often existing on opposing sides of the window or door, air transfer then occurs in the gap or space. Typically, this is seen in cold and hot weather when the cold air or heat escapes or enters the home. Furthermore, other elements, such as water and ice may leak or cause other problems in these spaces. Thus, in order to correct and avoid environmental effects, windows, doors, and the like are fitted with weather stripping, typically a solid or flexible strip running the length and/or height of the closure and attempting to cover the space within the gap.

Unfortunately, currently available weather stripping and its application does not sufficiently cover the separation between doors, windows, and other closures. In fact, often times, as identified above, as the structure, building, or concrete settles, a shift in the door, window or other closure occurs that causes the weather strip to act as a stop, preventing complete closure or opening of the door, window, or closure. Likewise, many of such devices continue to leave a space for air to enter or escape. In addition, currently available weather strips are often bulky, and, as a result, when such strips butt-up against either a door, a jamb, or each other, the door is held open. Likewise, most weather strips are stiff and awkward, making them difficult to work with and resulting in a very short effective life as they are constantly subjected to stress. Many current weather strips must also be applied by screws, nails and the like, providing unsightly components, and ultimately damaging the surfaces onto which the weather strip is placed.

Various attempts have been made to address some of these problems. For instance, multi-finger seal strips have been developed, including spaced apart fins which project in parallel orientation. Other weather strip devices having multiple fins for providing a door seal have also been attempted. Namely, devices including three flexible fins extending downwardly from the door for engaging the threshold and providing a seal at the bottom of the door have been used. It is further known to have the fins engage the door by means of a channel at the bottom of the door into which they are slid as a unit. Many of such devices include snaps or screws for securing the multiple fin strip in place on the door. Adjustable weather strip assemblies are also available. These assemblies typically include multiple portions folded or formed into a single weather strip. Unfortunately, such multi-finger strips remain subject to the common problems of current weather stripping application. Namely, a gap will exist or be formed as components shift. Likewise, the fins are not typically very durable, they are attached by damaging means, and continue to leave a space or cause a jamb when attempting to close the door, window or other closure.

As indicated, it is known to attach weather strips with the use of fasteners, such as screws and the like. It is also known to attach weather stripping without such fasteners. For instance, single strips of rubber-type weather stripping may be attached to doors, windows, and similar closures by sliding same into a groove. Alternatively, flexible weather strip members have been secured by a folded sheet metal strip which is further secured to a door by means of nails. Unfortunately, many such applications of weather stripping damage the surface onto which the are placed, i.e., drilling or nailing into the surface. Alternatively, the surface may need to be pre-cut or notched to accept a sliding piece of weather strip. As a result, the removal of the weather strip leaves unsightly portions on the remaining surface and provide gaps for the collection of water which may ultimately lead to rot. Furthermore, additional time and expense is required for the attachment of the weather stripping.

Likewise, weather strips have been composed of numerous materials such as rubber, plastic, and the like. However, such materials are not flexible or durable enough to last, do not provide an effective seal, are not generally attractive components that can be added to a door as trim, and are generally difficult to apply.

Accordingly, what is needed in the art is an improved weather strip and application of same which is easy to apply, provides effective sealing, and when removed does not damage the surface onto which it is placed. A further need exists for such features in a door or window. To date, an assembly of more than one weather strip mounted on adjacent surfaces (i.e., door and frame and/or door and corresponding door), which strips overlap to form a double seal, has not been available. Moreover, such a combination in which the weather strips are adhesively bonded in their respective locations, and/or composed of cloth have not been known or attempted. Uniquely, and surprisingly, such a combination provides an effective, durable, low-cost seal for a closure between two objects that is aesthetically pleasing, functional, and can be removed and/or replaced without damaging the surface onto which it is placed.

### SUMMARY OF THE INVENTION

The invention is embodied in a weather strip assembly and application of same for a door, window, or other closure.

More preferably, the invention is a weather strip assembly and application of same in which a first weather strip is operably attached to a first surface, and a second weather strip is operably attached to a second surface adjacent the first surface, wherein the second weather strip at least partially overlaps the first weather strip, forming a double seal between first and second surfaces. The first and/or second weather strip may be applied and secured to the respective surface by adhesive. Further, the weather strip may comprise a cloth fabric.

Such an assembly is capable of use in virtually any application where a gap between two objects must be sealed, is flexible enough to avoid impeding the proper functioning of a door, window, or other closure, is sufficiently durable to outlast current weather strips, is easy to mount, can be provided in a variety of colors to match decor, will not unravel, rip, tear, or fall apart, or separate from the adhesive, and will effectively seal the space between the two surfaces or objects.

Accordingly, it is a primary object of the present invention to provide a durable weather strip which is easy to apply, weather resistant, contains aesthetic qualities, and provides an effective seal for covering a gap or space between two objects.

Other aspects, features and details of the present invention can be more completely understood by reference to the following detailed description in conjunction with the drawings, and from the appended claims.

### BRIEF DESCRIPTION OF THE DRAWINGS

FIG. 1 is an illustration of an embodiment of the weather strip assembly of the present invention for a double door.

FIG. 1A shows a cut-away cross sectional view of the weather strip assembly of FIG. 1.

FIG. 1B shows a cut-away cross-sectional view of the weather strip assembly of FIG. 1 having one of the two doors open.

FIG. 2A shows a cut-away cross-sectional view of an embodiment of a double door weather strip assembly having the weather strip assembly mounted on the surface of each door opposite that shown in FIGS. 1-1B.

FIG. 2B shows a cut-away cross-sectional view of the embodiment of FIG. 2A, in which one of the two doors is open.

FIG. 3 is an illustration of an embodiment of the weather strip assembly of the present invention for a single door.

FIG. 3A shows a cut-away cross-sectional view of the weather strip assembly of FIG. 3.

FIG. 3B shows a cut-away cross-sectional view of the weather strip assembly of FIG. 3 having the door open.

FIG. 4A shows a cut-away cross-sectional view of an embodiment of a single door weather strip assembly having the weather strip mounted on the surfaces of the door and jamb or frame opposite that shown in FIGS. 3A-3B.

FIG. 4B shows a cut-away cross-sectional view of the embodiment of FIG. 4A, in which the door is open.

FIG. 5 is a close-up illustration of a single weather strip attachment to a surface of an embodiment of the present invention.

FIG. 6 is an illustration of an embodiment of the weather strip assembly of the present invention for a casement or pivoting window, having the window partially open.

FIG. 7 is an illustration of an embodiment of the weather strip assembly of the present invention for a sash, double hung, or sliding window.

### DETAILED DESCRIPTION OF PREFERRED EMBODIMENTS

The present inventive weather strip and application of same is embodied in a weather strip for a closure between two objects. More specifically, the weather strip shown and described is for use with a door and/or window. For the sake of clarity, only doors and windows are specifically described herein. However, one of ordinary skill in the art would understand that the present inventive system could be applied to any closure on any machine, building, structure, or device.

Referring generally to the Figures, the weather strip assembly of the present invention comprises a first weather strip operably attached to a first surface, and a second weather strip operably attached to a second surface which is adjacent to the first surface, wherein the second weather strip at least partially overlaps the first weather strip forming a double seal between the first and second surfaces. The weather strip assembly may further comprise an attachment of one or both weather strips by an adhesive. Further, the weather strips may comprise a cloth fabric.

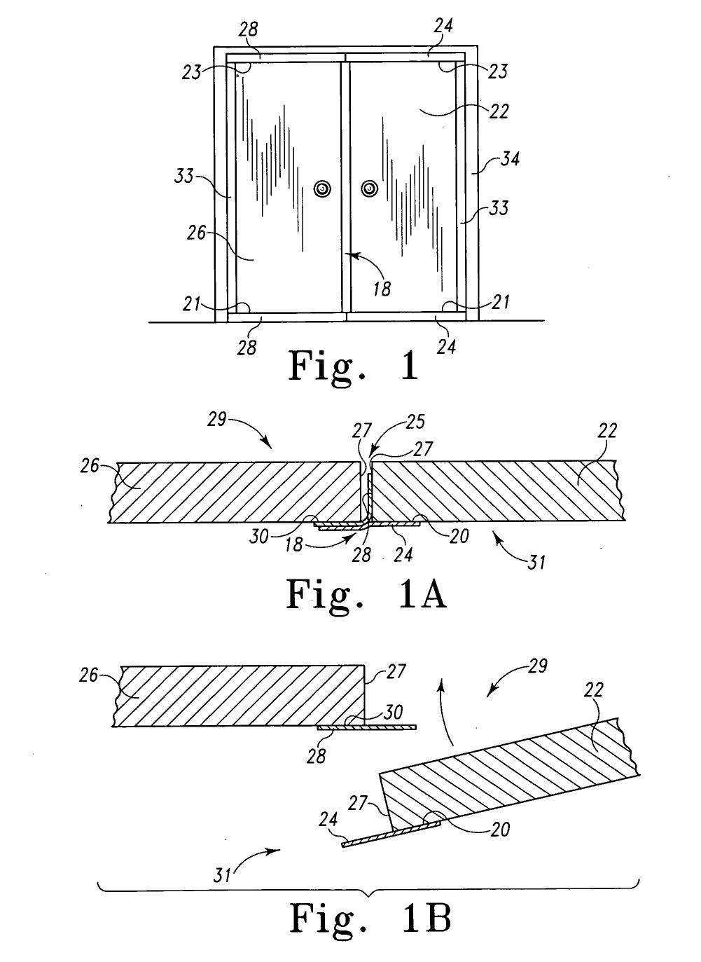

For reference, and purposes of discussion herein, for pivoting door and window assemblies the surface of the door or window facing the direction of pivot, as seen in FIGS. 1B, 2B, 3B, and 4B will be referred to as the “inner surface” 29, while the surface on the opposing side will be referred to as the “outer surface” 31. However, the invention is not limited thereto, as one of skill in the art would understand that either surface could be an inner or outer surface, and, in fact, any surface designation or identification would be acceptable for purposes of the present invention.

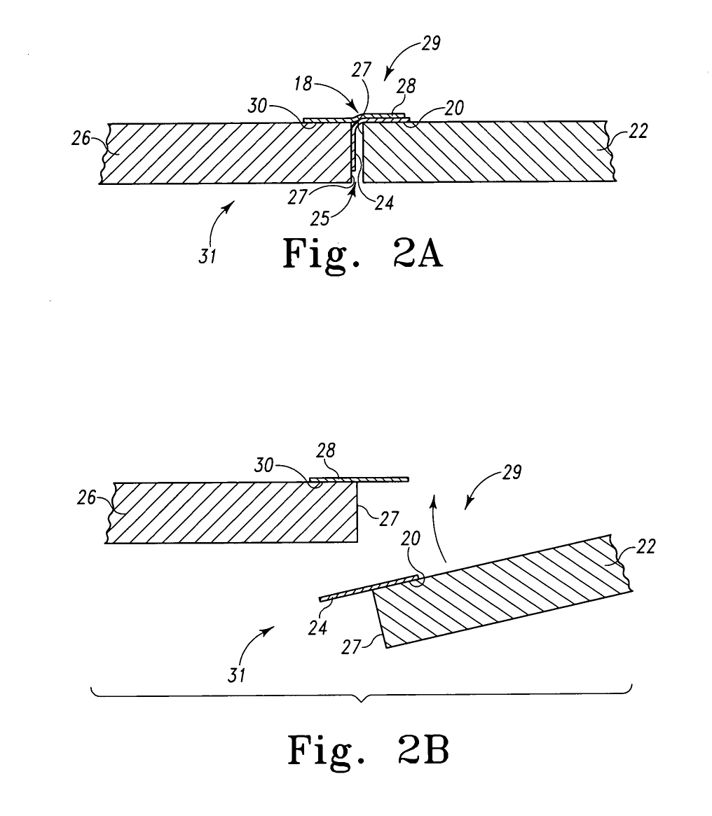

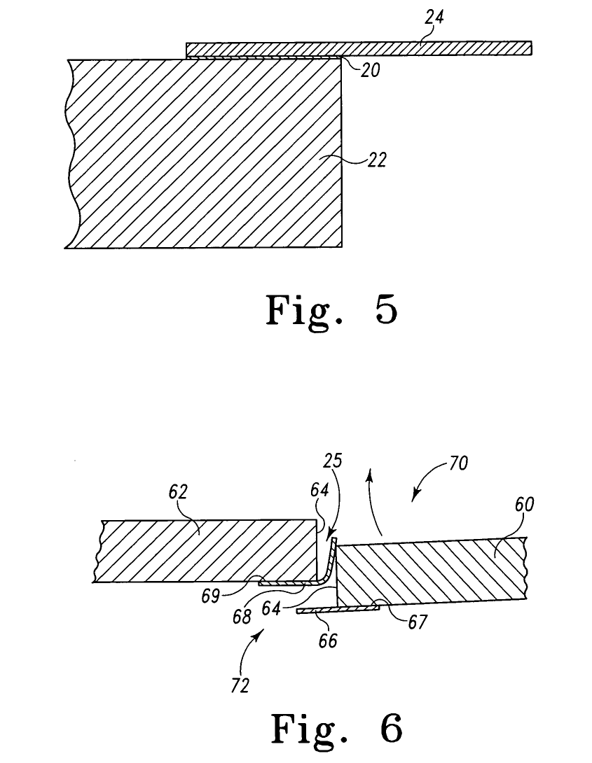

In a preferred embodiment of a double door installation assembly shown in FIGS. 1-2B, a first strip of adhesive 20 is applied on a first door 22. A first weather strip 24 is positioned and attached over the adhesive 20 so that when the door 22 is closed, the weather strip 24 is attached to the door 22, but extends beyond the door 22 to at least partially overlap a second door 26 and/or a second weather strip 28 across or within a gap 25 between the two doors. As will be understood from the disclosure herein, the adhesive and weather strip of any assembly herein may be applied separately in their respective location, or may be combined and applied to the respective surface as a unit. For ease of reference and understanding, the weather strip and adhesive are discussed separately herein. FIG. 5 illustrates a close-up view of the attachment of the weather strip to the door, window or other surface by means of adhesive. While door 22, weather strip 24, and a adhesive 20 are specifically identified in FIG. 5, as will be understood herein, any door 22, 26, 32, jamb 36, frame 34 or 62, window 39, 49, 60, adhesive 20, 30, 45, 51, 59, 67, 69, 47, 53 and/or weather strip 24, 28, 33, 44, 48, 50, 56, 58, 66, 68 can be interchanged with the respective components identified in FIG. 5. In a preferred embodiment, the overlap of the weather strip 24 with the second door 26 comprises at least one-eighth (⅛) inch from the outer edge 27 of the second door 26. However, it is contemplated that any amount of overlap that covers the gap 25 between the doors 22, 26 would be acceptable for purposes of the present invention.

As can be seen in FIGS. 1A and 1B, a second weather strip 28 is applied by means of a second adhesive strip 30 in the same manner as described above on the second door 26, so that when extending straight it overlaps the outer edge 27 of the first door 22. As the door 22 closes, it presses against the weather strip 28 on the closed door 26, causing the strip 28 on the closed door 26 to move or bend in the direction of door movement, pressing against the edge 27 of the door and wedging in between the two doors 22, 26. At the same time, the weather strip 24 on the open door 22 overlaps the closed door 26, and wedged weather strip 28, covering the gap 25 between the doors 22, 26, covering at least a portion of the wedged weather strip 28, and providing a double seal of weather strip 24, 28 at or in the gap 25 between the doors.

To accomplish the above seal, preferably, the weather strips 24, 28, are positioned along the surface adjacent outer edge 27 of the door 22, 26, spanning the entire height of the door 22, 26. A weather strip 24, 28 may also be attached along the bottom 21 and/or top edge 23 of the door 22, 26 and/or associated frame 34. Moreover, weather strips 33 may be applied on the hinged side of the door. These strips, likewise, may extend the entire length or width of the door (See FIG. 1). Moreover, as can be seen in FIGS. 2A and 2B, the weather strip assembly 18 may be applied to either side of the door 22, 26 (inside 29 or outside 31). Contrary to the embodiment disclosed in FIGS. 1A and 1B in which the weather strip assembly 18 is mounted to the outer surface 31 of the doors 22, 26, the closed door 26 may have a weather strip 28 attached by adhesive 30 on the inner surface 29 of the door 26. The pivoting or open door 22, likewise, has a weather strip 24 attached by adhesive 20 to an inner surface 29 of the door 22. Therefore, as the pivoting door 22 closes, the weather strip 24 contacts and presses against the outer edge 27 of the closed door 26, curving and/or bending opposite the direction of door 22 movement. When completely closed, the weather strip 28 attached to the closed door 26 at least partially overlaps the adjacent door 22 and/or weather strip 24, forming a double seal.

In the double door embodiment, either door 22, 26 can represent the closed door. Door 26 and its respective weather strip assembly is provided herein, merely for purposes of illustration. Of course, for either embodiment, as is common for a double door, both doors 22, 26 may pivot. In this instance, the door closest to the point of closure would be the equivalent of the closed door described above. Further, while specific doors are identified herein, the assembly could be reversed and applied to the opposite door without departing from the scope of the overall invention.

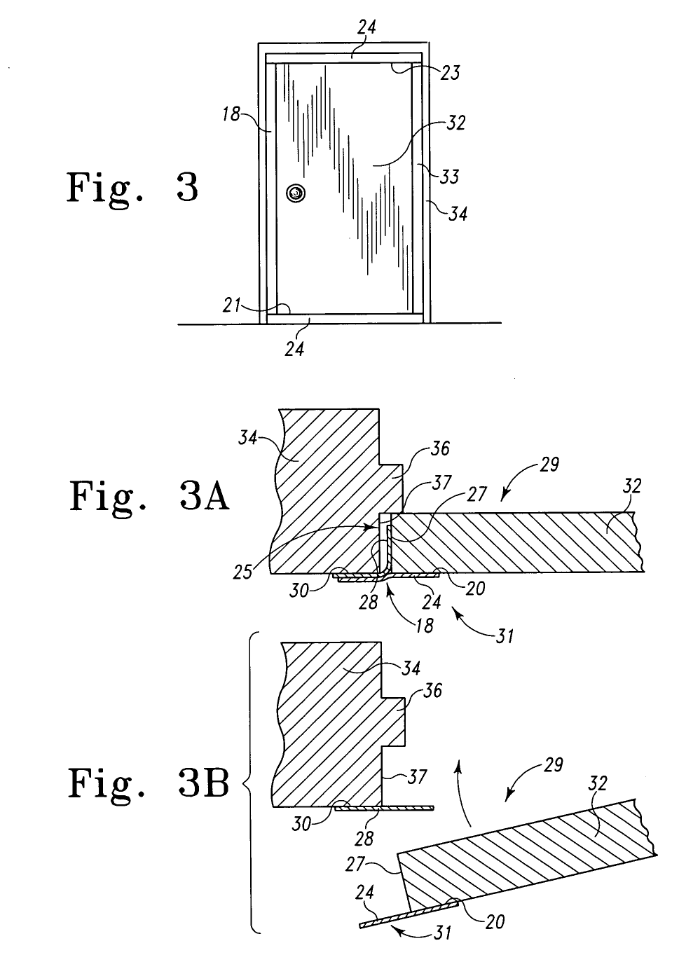

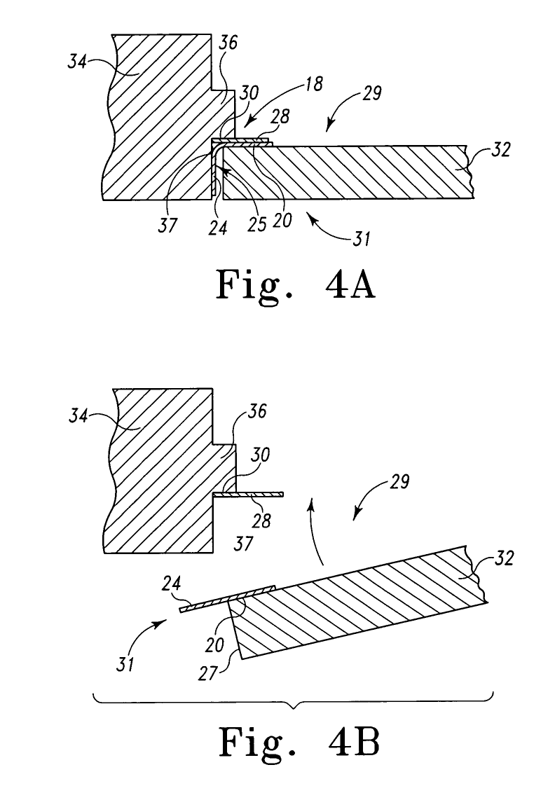

Referring to FIGS. 3-4B, in addition to a double door assembly, the instant invention is also applicable to a single door assembly. Namely, a single door 32 may be provided, as is common in the art, within a door frame 34 having a doorjamb 36. In this embodiment, the single door 32 is provided with a first weather strip 24 securely bonded or attached thereto by means of a first adhesive strip 20. Specifically, the first weather strip 24 is positioned and attached so that when the door 32 is closed, the weather strip 24 is attached to the door 32, but at least partially overlaps the door frame 34 and/or an adjacent weather strip 28, over or in the gap 25 between the frame 34, and the door 32. In a preferred embodiment, the overlap of the weather strip 24 with the frame 34 comprises at least one-eighth (⅛) inch from the outer edge 37 of the frame 34. However, it's contemplated that any amount of overlap that covers a portion of gap 25 would be acceptable for purposes of the present invention.

A second weather strip 28 is applied by means of a second adhesive strip 30 in the same manner on the door frame 34 as described above, so that when it extends straight it overlaps the single door 32. As a result, as the door 32 closes, it presses against the weather strip 28 on the door frame 34, causing the strip 28 to curve or bend in the direction of door 32 movement, pressing against the edge 27 of the door 32, and wedging between the door 32 and the frame 34 (See FIGS. 3A and 3B). At the same time, the weather strip 24 on the door 32 overlaps the frame 34 and/or wedged weather strip 28, covering at least part of the frame 34, and/or forming a double seal of weather strips 24, 28 at or in the gap 25 between the door 32 and frame 34. Similar to the double door 22, 26 described hereinabove, the weather strip 24, 28 may be applied to the inner surface 29 or outer surface 31 of the door 32 and/or jamb 36, or frame 34 (Compare FIGS. 3A-B, and 4A-B). Likewise, weather strips 24 and 28 may be attached at the top 23 or bottom 21 edge of the door 32 and/or associated frame 34. The weather strip 33 may also be provided on the hinged portion of the door 32. The weather strips 24, 28, like the double door assembly of FIG. 1, extend the length or height of the door.

With respect to the attachment of weather strips 24 and 28 to the inner surface 29 of the door 32, frame 34, or jamb 36, as shown in FIGS. 4A-B, the weather strip 24 is mounted by adhesive 20 to the door 32 so that it extends beyond the outer edge 27 of the door 32 and at least partially contacts or overlaps the frame 34. Similarly, the second weather strip 28 is attached by adhesive 30 to the doorjamb 36, and extends therefrom to at least partially overlap the door 32 and/or weather strip 24 when the door 32 is closed. Similar to the above, as the door 32 is closed, the first weather strip 24 contacts the frame 34 and/or jamb 36 and curves or bends opposite the direction of door 32 movement. The weather strip 24 presses against the surface 37 of the frame 34 or jamb 36 when the door 32 is closed. At the same time, the second weather strip 28 at least partially overlaps the first weather strip 24 and/or door 32, forming a double seal in the gap between the door 32 and the frame 34 and/or jamb 36.

While single (FIG. 3) and double door (FIG. 1) window assemblies are disclosed above, any door assembly and type is contemplated by the present invention, including but not limited to a folding door, a sliding door, a sliding/folding door, French doors, entry doors, storm/screen door, and the like. In addition, one or more weather strips may be used in the same or a similar manner to seal the gap at the top or the bottom of a door.

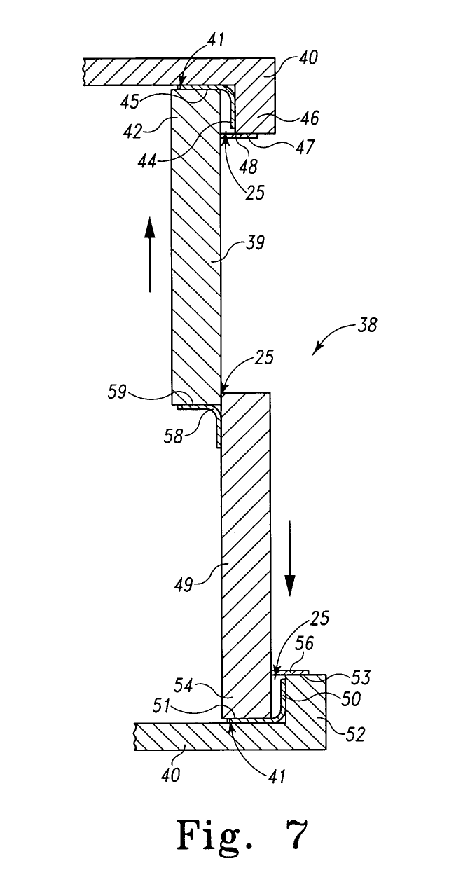

Various window applications are also contemplated by the present invention. As non-limiting examples shown in FIGS. 6 and 7, the weather strip assembly 18 of the present invention may be applied to a sliding window, such as a sash, single hung or double hung window 38, as well as a casement window 60.

Referring specifically to a casement window, FIG. 6, the embodiment shown comprises a roll-out window in which at least one window 60 pivotally rotates out of or into a window frame 62. The window 60 and frame 62 each have an outer edge 64. A casement window weather strip 66 is positioned and attached over the outer edge 64 of the window 60 by an adhesive 67. Preferably, the weather strip 66 extends beyond the window 60 and outer edge 64. When the window 60 is completely closed, the weather strip overlaps at least a portion of the frame 62 of the casement window 60 and/or an adjacent weather strip 68 similar to the doors 22, 26, 32 shown in FIGS. 1 and 3. A second casement window weather strip 68 may be positioned and attached by adhesive 69 on a surface of the frame 62. Preferably, the second casement window weather strip 68 is attached to, but extends beyond the outer edge 64 of the frame 62, so that when the window 60 closes, the window 60 presses against the second weather strip 68, causing same to bend or curve in the direction of window 60 movement. As a result, when the window is completely closed, the first and second weather strips 66, 68 form a double seal at and/or in the gap 25 between the window 60 and the frame 62. Similar to the doors described above, the opposite arrangement may also occur, in which the first weather strip 66 is attached to the inner surface 70 of the window and the second weather strip 68 is attached to the inner surface 70 of the frame 62, resulting in the first weather strip 66 curving opposite the direction of window 60 movement, and the second weather strip 68 remaining substantially straight across the gap 25 between the window 60 and the frame 62. Similar to the double door 22, 26 weather strip assembly disclosed in FIG. 1, the casement window 60 may likewise be provided with an equivalent weather strip assembly for a double window (not shown). Likewise, one or more weather strips may be applied at the top and/or bottom of the window and/or on the hinged side of the window. The weather strips 66, 68 preferably extend the length and/or height of the window.

The present invention may also be used in a sliding, sash, single hung, or double hung window. The sliding window and present application may be applied in either a vertical or horizontal sliding window. In detail, as shown in FIG. 7, the sash window 38 disclosed comprises a window frame 40 surrounding the window 38. As is common for a sash, single hung, or double hung window, the window 38 has an a pair of slidable windows 39, 49. The first window 39 has a first outer rail 42 that surrounds the glass (not shown). Likewise, the second window 49 includes an outer rail 54 surrounding the glass (not shown), and will be referred to herein as the second outer rail 54. The weather strip of the preferred embodiment is applied in at least one of three locations, and more preferably, all three locations. Namely, weather strips are attached at or near the contact of the first outer rail 42 and the window frame 40, at or near the contact of the second outer rail 54 and the window frame 40, and at or near the contact between the first 39 and second 49 sliding windows.

In detail, as shown in FIG. 7, a first window weather strip 44 is positioned and attached on at least a portion of the first outer rail 42. Preferably, the weather strip 44 is attached by adhesive 45 across or along the portion of the rail 42 that abuts or is contained within the recess 41 of the window frame 40 when the first window 39 is completely closed. The first window weather strip 44 is further positioned so that at least one end thereof extends beyond the first outer rail 42, and, when straight, at least partially overlaps an extending portion 46 of the window frame 40 and/or frame weather strip 48. In addition to the window weather strip 44, a first frame weather strip 48 is attached by adhesive 47 to the extending portion 46 of the window frame 40, and preferably on at least a portion of same. The frame weather strip 48 extends towards the window 39, to a position preferably immediately adjacent the window 39, and may further at least partially overlap or contact a portion of the window 39. As a result, when the first window 39 is closed, the first window weather strip 44 presses against a surface of the extending portion 46 of the window frame 40, curving opposite the direction of window 39 movement. In addition, the first frame weather strip 48 remains in close contact with or against the window 39. The combination of first window and frame weather strips 44, 48, therefore, forms a double seal at or in a gap 25 between the first window 39 and the frame 40.

The second window 49, as indicated, has an outer rail 54 that surrounds the glass (not shown). The second window weather strip 50 is, as above, positioned and attached by adhesive 51 on the second window outer rail 54. Namely, a second window weather strip 50 is positioned and attached on at least a portion of the second outer rail 54. Preferably, the weather strip 50 is attached across or along the portion of the rail 54 that abuts or is contained within the recess 41 of the window frame 40 when the second window 49 is completely closed. The second window weather strip 50 is further positioned so that one end thereof extends beyond the second outer rail 54, and, when straight, at least partially overlaps a second extending portion 52 of the window frame 40 and/or the frame weather strip 56. A second frame weather strip 56 is attached by an adhesive 53 to the extending portion 52 of the window frame 40, and preferably at least to a portion of same in the same manner described above for the first frame weather strip 48. In addition, the second frame weather strip 56 extends towards the window 49 to a position preferably immediately adjacent the window 49, and may further at least partially overlap or contact a portion of the window 49. As a result, when the second window 49 is closed, the second window weather strip 50 presses against a surface of the second extending portion 52 of the window frame 40, curving opposite the direction of window 49 movement. In addition, the second frame weather strip 56 remains in close contact with or against the window 49. The combination of second window and frame weather strips 50, 56, therefore, forms a double seal at a gap 25 between or in the second window 49 and the frame 40.

In addition to the above, at least one central weather strip 58 may also be attached to at least one of the first and/or second outer rail 42, 54 on the first 39 or second 49 window. Preferably, the central weather strip 58 is positioned and attached by adhesive 59 on one window 39, 49 to at least partially overlap or contact a portion of the adjacent window 39, 49. As a result, the central weather strip 58 curves slightly in the direction of window movement as the window is closed. The central weather strip 58 provides an additional seal between the first and second windows 39, 49 in the center of same. It is further contemplated that a second weather strip may be added in the central location to the opposite window to form a double seal of weather strips between the windows 39, 49.

While a sash and a casement window are specifically described, any type of window is contemplated for use with the present invention, including but not limited to, french windows, casement windows, sash or double hung windows, awning windows, horizontal and vertical pivoting windows, bow/bay windows, circle head windows, fixed frame windows, sliding windows, slide-folding windows, louvered windows, skylights, and the like. Furthermore, one or more weather strips may be used in the same or a similar manner to seal the gap at the top or the bottom of a window in a casement or pivoting window, or on the sliding sides of a sash window, and the like.

For any assembly described, one or more of the weather strips may be fastened or attached to the window by adhesive. In this instance, the weather strip is attached by positioning the adhesive, such as tape, between the weather strip and the surface onto which it is placed (FIG. 5). The weather strip and adhesive may be attached separately, or as a combined unit. Furthermore, the weather strips may be composed of cloth fabric and the like.

In addition to windows and doors on buildings and the like, it is contemplated that the present invention may also be used and applied as described above to windows, doors, closures, and other seals between two adjacent objects such as, in automotive or vehicle, marine, train, aircraft, and consumer or commercial appliance, applications and the like. More generally, the present invention may be used for any closure where a seal may be needed to prevent the transmission of air and other gases or to reduce the effects of elemental or environmental factors.

In a preferred embodiment, the weather strip described herein comprises a fabric material, and most preferably a cloth material. The cloth weather strip of the present invention contains weather resistant properties, is flexible, durable and may be colored to match door and/or room decor. More specifically, the fabric of the preferred embodiment dries quickly. Preferably, the fabric is water and/or weather resistant.

Various widths, materials, sizes, and locations can be used for the cloth, depending upon the composition of the surface it is applied to, the intended purposes, the location of the door (inside or outside), the gap between the doors, and the size of components, such as, for example the doorjamb 36. The preferred embodiment comprises a woven edge ribbon. As is known, a woven edge ribbon has finished selvedges or edges which will not fray. Typically, such ribbon is washable, and even dry-cleanable. The ribbon can further comprise a wire-edge woven ribbon, having a wire, such as a thin copper wire, woven into the edges. Alternatively, the fabric can comprise a sheer ribbon, metallic ribbon, printed and/or patterned ribbon, as well as a variety of colors and widths. Cut-edge ribbon, and/or ribbon treated with a stiffening agent to give it body may also be used. Advantageously, ribbon can be colored, printed, textured, and cut in a variety of ways to form different appearances. Thus, the use of the weather strip of the preferred embodiment can be colored or textured to match room, building, wall, window, or door decor, to match or complement same. As a result, users are able to apply a weather strip which will be effective and functional, yet aesthetically pleasing. Further, as will be discussed in further detail below, the weather strip can be easily removed without damage to the surface to which it is applied, and/or may be replaced by a different color, design, or texture as the surface appearance or décor changes.

Standard commercially available ribbons are made of 100% polyester and can range from one-sixteenth ( 1/16) inch (1.5 mm) to three (3) inches (77 mm) in width. The preferred embodiment comprises a colorfast ribbon of approximately one (1) inch width. While ribbon is specifically disclosed, other cloths and/or fabrics may be used. Namely, any fabric material suitable for the purposes provided herein would be acceptable as a weather strip for the present invention.

Contrary to current products which use foam, rubber, bristle, and other similar components, cloth fabric maintains a seal between the respective surfaces even when severe movement or shifting of the surfaces occurs. For instance, current products typically lose their ability to seal a door or passageway if, for example, the frame shifts, or the threshold moves up or down. Cloth, on the other hand, is flexible enough to accommodate shorter distances between the door/window and its frame or nearby elements such as pavement. Likewise, due to this flexibility of cloth, a wider weather strip can be applied to the door, window, or other closure to anticipate a shift resulting in an increased gap. Further, due to this flexibility, debris in the path of the weather strip will not inhibit movement. Moreover, cloth does not impede the movement of the door, as it is flexible enough to accommodate a moving object. Thus, cloth will continue to hold its seal when the jamb, door, threshold or other structure moves.

As indicated hereinabove, the weather strips of the present invention are adhesively attached to the respective surface. Namely, an adhesive such as glue, tape, or other tacky substance is provided which contains properties that retain adhesion sufficiently to withstand extreme hot and cold, yet can be removed without leaving remnants of same behind. In the preferred embodiment, the adhesive comprises a thin tape, such as a double-sided tape, which may be clear or colored, and capable of adhering to both the weather strip and the surface on which it is placed. This adhesive ideally can sustain moisture up to at least twenty-four (24) hours or more. Further, a thin adhesive is applied so that the end product of the combined weather strip assembly is nearly flat against the surface (See FIG. 5). To accommodate these features, it is contemplated that the adhesive may vary based upon the surface to which it is applied, i.e., plastic; metal, including, but not limited to aluminum and steel; fiberglass; wood; fabric; rubber; and the like. Preferably, the adhesive of the present invention will have the following properties: a peel adhesion (PSTC mod./180°) to stainless steel of 20 minutes @ RT-initial (oz/inch=100, N/25 mm=27); a holding power (PSTC 7 mod./178°) of 2.2 psi (1×1×100 g) @ RT; a service temperature range of −40° F. to 200° F.; a humidity resistance equivalent to a percent peel retention after one week @100° F. (38° C.)/100% RH—96%; and a water resistance of percent peel retention after a 24 hr. soak=95%. An adhesive having such properties is available from Materials Converting, 11c of West Allis, Wisconsin, identified as Scapa UP3040 tape.

The weather strip assembly of the present invention has many advantages. The weather strips effectively and efficiently retain cool or hot air and keep the cool or hot air out depending on the climate. The weather strips further provide control of static pressure, by eliminating the flow of air into or out of the room or building as a result of pressure variances. Moreover, the weather strips, in fact, will work even more effectively when wind presses or blows against the weather strips. Uniquely, the weather strip assembly of the present invention provides a reassuring sound (such as a suction or seal) when the door, window, or other closure is closed that the user will associate with a tight seal.

The method of application of an embodiment of the weather strip assembly 18 of the present invention will now be described in further detail herein. A first weather strip 24, as indicated above, is attached to a first surface, such as a portion of a door 22 (See FIG. 5). The first weather strip 24 is attached by a first adhesive 20. The first adhesive 20 may either be applied to a surface of the weather strip 24, or the first surface 22. In either case, the adhesive 20 will be positioned between the first weather strip 24 and the first surface 22 so as to securely and operatively attach the weather strip 24 to the first surface 22. Preferably, the first weather strip 24 is attached to at least partially overlap the gap 25 between the adjacent surfaces, and may at least partially overlap the second surface, such as a second door 26 or doorjamb 36 or frame 34 (See FIGS. 1-4B). As a simple, light weight, strip 24 with few components, the weather strip 24 may be easily attached by applying pressure to the weather strip 24 positioned as described above. Namely, an individual could simply run his or her thumb up or down the length of the weather strip 24 to attach same in place. As a result, the weather strip 24 engages the adhesive 20 and almost instantly sets, securing the weather strip 24 in place.

A second 28 and additional weather strips may be attached with adhesives 30 in the same manner and positioned as described above on an adjacent surface, and therefore will not be further discussed herein. When each weather strip 24, 28 is secured in place over the adjacent surfaces, the gap 25 between same is sealed by a double layer of weather stripping.

As demonstrated herein, the weather stripping and application of same disclosed can be used in numerous applications, such as doors, windows and the like. Attractive applications of the weather strip include pivoting single and double window and door assemblies, as well as sash or double hung windows. However, the invention is not limited thereto, as one of ordinary skill in the art with this disclosure before him would understand that the present weather strip assembly and application of same can be applied in any structure, machine, device, or closure where a seal is needed between two objects.

The various mechanisms for the weather strip assembly and application of same disclosed herein may be combined in numerous combinations, and the invention should not be limited to the particular combinations described and illustrated herein. For example, it is contemplated that a weather strip assembly could be applied to both sides of the door, window, or other closure to provide two double seals in the gap there between. Likewise, it would be obvious to modify the weather strip assembly to use other flexible weather strip compositions and other attachment mechanisms. Additionally, the weather strips could be attached to the inner surface, such as 27, 37, and without departing from the scope of the present invention.

Presently preferred embodiments of the present invention and many of its improvements have been described with a degree of particularity. The previous description is of preferred examples for implementing the invention, and the scope of the invention should not necessarily be limited by this description.

What is claimed is:

1. A weather strip assembly comprising:
a first weather strip operably attached to a first surface and extending a distance from said surface;
a second weather strip operably attached to a second surface and extending a distance from said surface; and
when said second surface is adjacent said first surface, said second weather strip at least partially overlaps said first weather strip over at least a portion of said distance forming a double seal between said first and second surfaces.

2. The weather strip assembly of claim 1, further comprising at least one of said first and second weather strips at least partially overlapping said adjacent surface.

3. The weather strip assembly of claim 2, wherein said overlap comprises an amount of at least ⅛ inch.

4. The weather strip assembly of claim 1, further comprising at least one of said first and second weather strips attached to said surface by an adhesive.

5. The weather strip of claim 4, wherein said adhesive is at least partially weather resistant.

6. The weather strip assembly of claim 1, wherein at least one of said first and second weather strips comprises a fabric.

7. The weather strip of claim 6, wherein said fabric is at least partially weather resistant.

8. The weather strip assembly of claim 6, wherein said fabric comprises cloth.

9. The weather strip assembly of claim 6, wherein said fabric is colored for a decorative finish.

10. The weather strip assembly of claim 1, further comprising a gap between said adjacent surfaces.

11. The weather strip assembly of claim 1, wherein at least one of said first and second surfaces comprises a door.

12. The weather strip assembly of claim 1, wherein at least one of said first and second surfaces comprises a doorjamb.

13. The weather strip assembly of claim 1, wherein at least one of said first and second surfaces comprises a door frame.

14. The weather strip assembly of claim 1, wherein at least one of said first and second surfaces further comprises a window.

15. The weather strip assembly of claim 1, wherein at least one of said first and second surfaces further comprises a window frame.

16. The weather strip assembly of claim 1, wherein said first and second surfaces further comprise a closure on at least one of a building, structure, vehicle, train, aircraft, marine vehicle, and appliance.

17. The weather strip assembly of claim 1, further comprising a third weather strip attached to at least one of a base surface and a top surface, said third weather strip at least partially contacting an adjacent surface.

18. The weather strip assembly of claim 17, further comprising a fourth weather strip attached to at least one of the base surface and a top surface, said fourth weather strip at least partially contacting an adjacent surface.

19. A method of application of a weather strip comprising:
attaching a first weather strip to a first surface, said first weather strip extending beyond said first surface a first distance;
attaching a second weather strip to a second surface, said second weather strip extending beyond said second surface a second distance; and
overlapping said first weather strip and said second weather strip when said surfaces are adjacent one another, forming a double seal between said first and second surfaces.

20. The method of claim 19, further comprising attaching at least one of said first and said second weather strip by an adhesive.

21. The method of claim 19, wherein at least one of said first and said second weather strips comprise fabric.

22. The method of claim 21, wherein said fabric further comprises cloth.

23. A weather strip assembly for a door comprising:
a first weather strip operably attached to a surface on a first door, said first weather strip attached to said surface by an adhesive and extending a distance from said first door;
a second weather strip operably attached to a surface on at least one of a second door and a doorjamb adjacent said first door, said second weather strip attached to said surface by an adhesive, extending a distance from said second door and doorjamb, and at least partially overlapping said first weather strip forming a double seal between said first and second surfaces when said door is closed.

24. A weather strip assembly for a double hung window comprising:
a window frame having a first window and a second window slidably disposed within said frame;
a first window weather strip adhesively attached near a surface of said first window which can be placed in closeable contact with said frame, said first window weather strip having an edge thereof at least partially overlapping a portion of said frame;
a second window weather strip adhesively attached near a surface of said second window which can be placed in closeable contact with said frame, said second window weather strip having an edge thereof at least partially overlapping a portion of said frame;
a first frame weather strip adhesively attached to at least a portion of said frame, said first frame weather strip having an edge thereof in at least partial contact with said first window when closed;
a second frame weather strip adhesively attached to at least a portion of said frame, said second frame weather strip having an edge thereof in at least partial contact with said second window when closed, wherein when said first and second windows are closed, said window and frame weather strips overlap to form a double seal at said first window and said second window; and
a central weather strip adhesively attached to at least one of said first and second windows, said central weather strip at least partially overlapping a portion of said adjacent window forming a seal at the contact of the first and second windows.
